(19) United States
(12) Patent Application Publication
(10) Pub. No.: US 2020/0028775 A1
(43) Pub. Date: Jan. 23, 2020

(54) Apparatus and Method for Decentralized Anonymous Communication

(71) Applicant: MOAC BLOCKCHAIN TECH INC, Palo Alto, CA (US)

(72) Inventor: Xiaohu Chen, Mountain View, CA (US)

(21) Appl. No.: 16/039,326

(22) Filed: Jul. 19, 2018

(51) Int. Cl. H04L 12/733; H04L 12/721

(52) U.S. Cl. CPC H04L 45/20; H04L 45/44

(57) ABSTRACT

Decentralized anonymous communication between nodes within large-scale peer-to-peer networks is provided by a pool of link nodes and a resource control mechanism. One or more link nodes within the pool of nodes are selected to construct a communication channel between a source node and a destination node included in the network of nodes. The communication channel includes a number of individual communication links, each link being between a different pair of nodes. The establishment of communication links is handled anonymously by the link nodes, with the resource control mechanism providing information on link node availability. The communication channel is constructed in such a way that no individual node included in the communication channel has knowledge of the entire node formation of the channel.

### TECHNICAL FIELD

The present disclosure relates generally to communication over large-scale networks, and more particularly, to apparatuses and methods for decentralized anonymous communication between nodes within large-scale peer-to-peer networks.

### BACKGROUND

FIG. 1 is an illustration of a conventional peer-to-peer network having a large number of distributed nodes forming a large-scale decentralized network or system. The number of nodes in a large-scale decentralized network may be, for example, around 10,000. Because of the large number of nodes, communication between nodes across the entire network is difficult and prone to inefficiencies. Accordingly, technologies have been developed to improve the efficiency and processing capabilities of large-scale decentralized networks.

In one such technology, more efficient communication between nodes is enabled by logically grouping the nodes into shards and limiting communication by the nodes in a shard to direct, peer-to-peer communication with other nodes in the same shard. The number of nodes contained in a shard is much smaller than the number of nodes in the entire network 100. For example, a shard may include 100 nodes.

Direct, peer-to-peer communication between nodes in a shard, however, greatly reduces the security of the large-scale decentralized network because the number of nodes in the shard is much smaller than the number of nodes in the entire large-scale decentralized network. For example, a shard comprising 100 nodes is much more susceptible to a distributed denial-of-service (DDOS) attack than the entire large-scale decentralized network comprising 10,000 nodes.

Therefore, while grouping of nodes into shards in a large-scale decentralized networks is necessary to achieve scalability of the network, such grouping essentially results in a number of small-scale networks, each corresponding to a shard, having a reduced level of security. Accordingly, secure communication among nodes within these small-scale networks or shards poses a great challenge.

Existing technology attempts to address the security challenge posed by small-scale networks by distributing the communication between nodes in a shard to the entire large-scale decentralized network. To this end, and with reference to FIG. 1, a source node SRC within a shard that seeks to communicate with a destination node DEST within the same shard broadcasts a message to the entire large-scale decentralized network. Nodes within the same shard as the source node SRC and outside the shard receive the broadcast message. The destination node DEST recognizes the message as being intended for it and processes the message accordingly to obtain the communication information included in the broadcast message. The source SRC and destination DEST nodes within the shard thus achieve logical communication within the shard without direct communication with each other. Thus security of the shard is maintained. Nodes within the large-scale decentralized network that do not belong to the shard also received the message, but do not recognize the message as being intended for them, and thus ignore the message.

While security of the shard is maintained by this existing technology, several drawbacks arise from this technology, particularly with respect to its broadcast feature. Broadcasting a message to the entire large-scale decentralized network requires each node in the network to at least partially process the message to determine if it is intended for it. This inefficiently consumes network resources. Furthermore, such broadcasting unnecessarily exposes the communication information included in the message to entities outside of the shard.

It is therefore desirable to provide for secure communication between nodes within a large-scale decentralized network without exposing communication information across the network. It is further desirable to provide this secure communication in a way that invokes a level of anonymity within the network. The concepts disclosed below address these needs and others.

### SUMMARY

Decentralized anonymous communication between nodes within large-scale peer-to-peer networks is provided by a pool of link nodes and a resource control mechanism. One or more link nodes within the pool of link nodes are selected to construct a communication channel between a source node and a destination node included in the network. The communication channel includes a number of individual communication links, each link being between a different pair of nodes. The establishment of communication links is handled anonymously by the link nodes, with the resource control mechanism providing selection of link nodes based on availability. The communication channel is constructed in such a way that no individual node included in the communication channel has knowledge of the entire node formation of the channel.

In one aspect of communication channel construction, a first link node in a network of link nodes establishes a first communication link with a first node, which may be the source node or another link node. The first communication link, which is between the first node and the first link node, may be established by the first link upon receipt of a link request from first node. The first link node also establishes another communication link. This other link may be a second communication link between the first link node and a second link node in the pool of link nodes or it may be a final communication link between the first link node and the destination node. The second communication link may be established by the first link upon transmit of a link request from first link node to the other node. Thus, two communication links, each with a different node, are established by the first link node.

In another aspect of communication channel construction, a resource control mechanism facilitates construction of a communication channel between a source node and a destination node by assisting the source node and other nodes, with link node selection based on the availability of link nodes. For example, the resource control mechanism may provide the source node with a node identifier identifying a first link node within a pool of link nodes selectable for use in establishing a first communication link of the communication channel. The resource control mechanism then provides the first link node with a node identifier identifying a second link node within the pool of link nodes selectable for use in establishing a second communication link of the communication channel. The resource control mechanism continues this process until a final communication link with the destination node is established. The resource control mechanism thus manages the selection of link nodes for use in constructing the communication links between the source node and the destination node.

It is understood that other aspects of apparatuses and methods will become readily apparent to those skilled in the art from the following detailed description, wherein various aspects of apparatuses and methods are shown and described by way of illustration.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is an illustration of a conventional large-scale decentralized network, including groups of nodes forming shards, wherein communication between nodes in the shard is conducted over the network.

FIG. 2 is an illustration of a large-scale decentralized network, including groups of nodes forming shards, a pool of nodes, or link-node group, available to construct communication channels between nodes in a shard, and a resource control mechanism for managing the link-node group.

FIGS. 3A and 3B are flow diagrams of a process for creating a communication channel between two nodes in the shard of FIG. 2 using one or more link nodes in the link-node group.

FIG. 4 is a flowchart of a method of constructing at least a portion of a communication channel between a source node and a destination node.

FIG. 5 is a flowchart of method a facilitating construction of a communication channel between a source node and a destination node.

FIG. 6 is a block diagram of an apparatus corresponding to, in one embodiment, a node configured to implement the method of FIG. 4, and in another embodiment, a resource control mechanism configured to implement the method of FIG. 5.

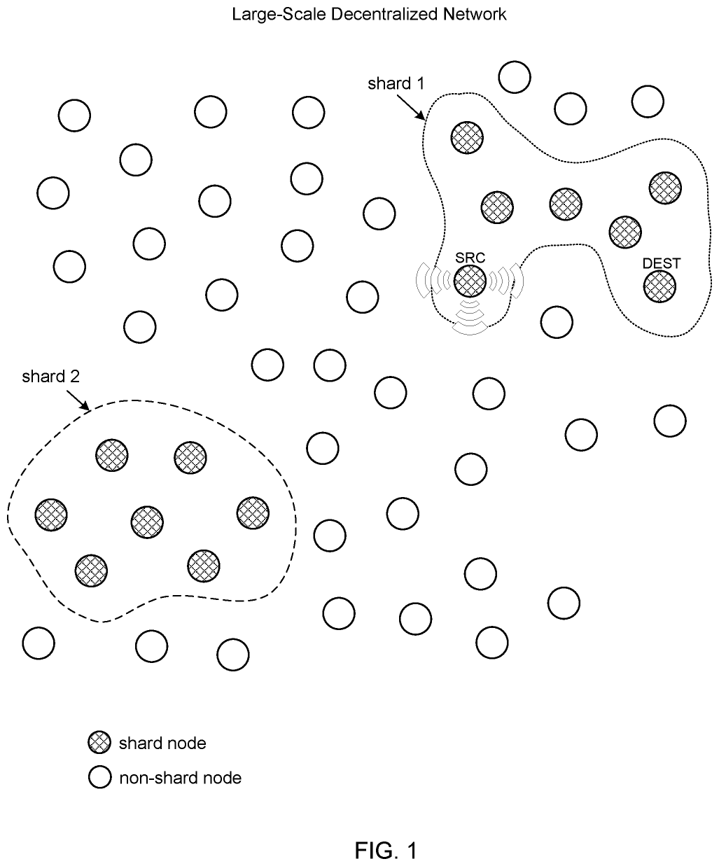

### DETAILED DESCRIPTION

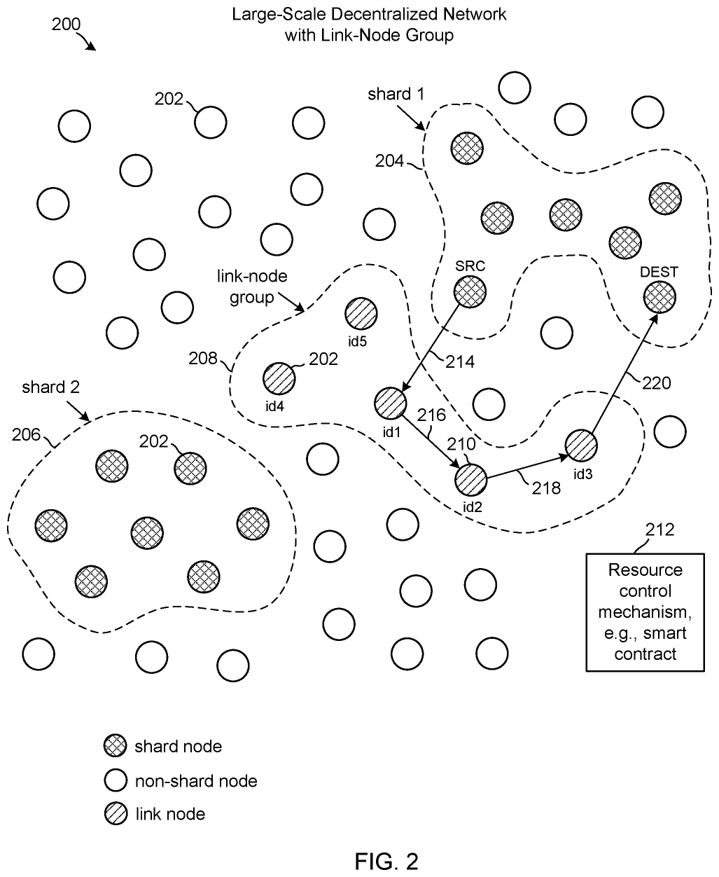

FIG. 2 is an illustration of a peer-to-peer network 200 having a large number of distributed nodes 202 forming a large-scale decentralized network or system. The number of nodes 202 in the large-scale decentralized network 200 may be, for example, around 10,000. Nodes 202 within the large-scale decentralized network 200 are grouped into shards 204, 206 and a pool of link nodes, referred to as a link-node group 208. While a large number of nodes 202 and shards 204, 206 may be present in a large-scale decentralized network, for ease of illustration, a reduced number of nodes and shards are shown in FIG. 2.

The shards 204, 206 represent logical groupings of nodes 202 within the large-scale decentralized network 200. For example, the node groupings may be based on the needs of an application being run on the nodes in the shard 204, 206. To this end, nodes 202 in a shard 204, 206 may be coordinated to perform certain tasks through, for example, a consensus protocol.

In accordance with the present disclosure, the link-node group 208 in the large-scale decentralized network 200 represents a pool of nodes 202. A function of the link-node group 208 is to enable anonymous, decentralized communication between nodes 202 within a same shard 204, 206. A resource control mechanism 212 manages the link-node group 208 and the use of these links nodes by other nodes outside the link-node group. The resource control mechanism 212 may be, for example, embodied as a smart contract deployed in the public blockchain system like Bitcoin and Ethereum.

The link-node group 208 in conjunction with the resource control mechanism 212 facilitates construction of a communication channel between nodes within a shard that need to communication. For example, the pool of link nodes 210 may be made available to the source node SCR and the destination node DEST in the first shard 204. Based on this availability, the source node SCR may establish a first communication link 214 with a first link node id1. Once this first communication link 214 is established, the link-node group 208 in conjunction with the resource control mechanism 212 enables further construction of the communication channel. To this end, the first link node id1 establishes a second communication link 216 with a second link node id2, after which the second link node id2 establishes a third communication link 218 with a third link node id3, after which the third link node id3 establishes a final communication link 220 with the destination node DEST.

While four communication links are shown in FIG. 2, the number of communication links may be different. For example, the number of communication links may be two, in which case only one link node 210 is used, while the maximum number of communication links is bound by the number of available link nodes 210. The number of communication links and hence the number of link nodes 210 included in the communication channel is configurable by specifying the number of hops when initializing. On this point, it is noted that on the upside a greater number of communication links provides a higher degree of anonymity to the communication channel, while on the downside increasing the time of communication.

In one configuration, the link nodes 210 in the link-node group 208 may be available for rent or lease by the nodes seeking to communicate. Link nodes 210 may be rented or leased in accordance with a certain protocol or rule. For example, as previously mentioned, in a blockchain environment, the pool of available link nodes 210 can be controlled by a resource control mechanism 212, e.g., a smart contract. Other nodes 202 within the large-scale decentralized network 200 can be added to the pool of link nodes 210 in the link-node group 208 by initially posting a bond. Once in the pool, these link nodes 210 are available for rent or lease by users or applications through nodes in the shards 204, 206. In exchange for their use, accounts associated with the link nodes 210 may be compensated, for example, through an account credit in term of tokens.

The disclosed link-node group 208 and resource control mechanism 212 that facilitate construction of a communication channel between nodes within a shard, referred to going forward as “shard nodes,” provides numerous benefits. First, by enabling the exchange of information between two shard nodes through link nodes 210 that are outside of the shard 204, communication between the two shard nodes is anonymous with respect to the other nodes within the shard 204. Second, communication via link nodes 210 outside of the shard 204 provides a more secure communication channel that is resistant to DDOS attacks. Third, communication between two shard nodes through the link nodes 210 reduces the volume of direct communication between nodes within the same shard and thus reduces the burden on the entire large-scale decentralized network 200. Fourth, communication through the link nodes 210 also avoids exposing the information being communicated between shard nodes to irrelevant nodes within the shard itself and within the entire large-scale decentralized network 200. Finally, the communication channel constructed by link nodes 210 within the link-node group 208 provides faster communication between shard nodes.

Having thus described the high level operation of a link-node group that facilitates construction of communication channels between nodes within a large-scale decentralized network, a more details description of communication channel formation follows.

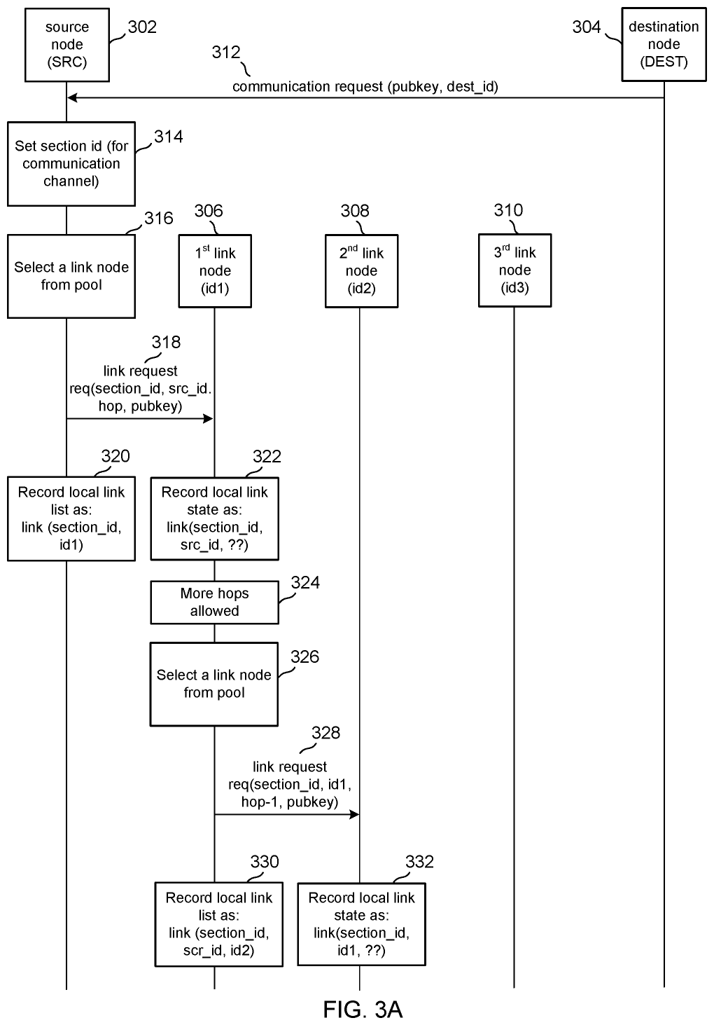

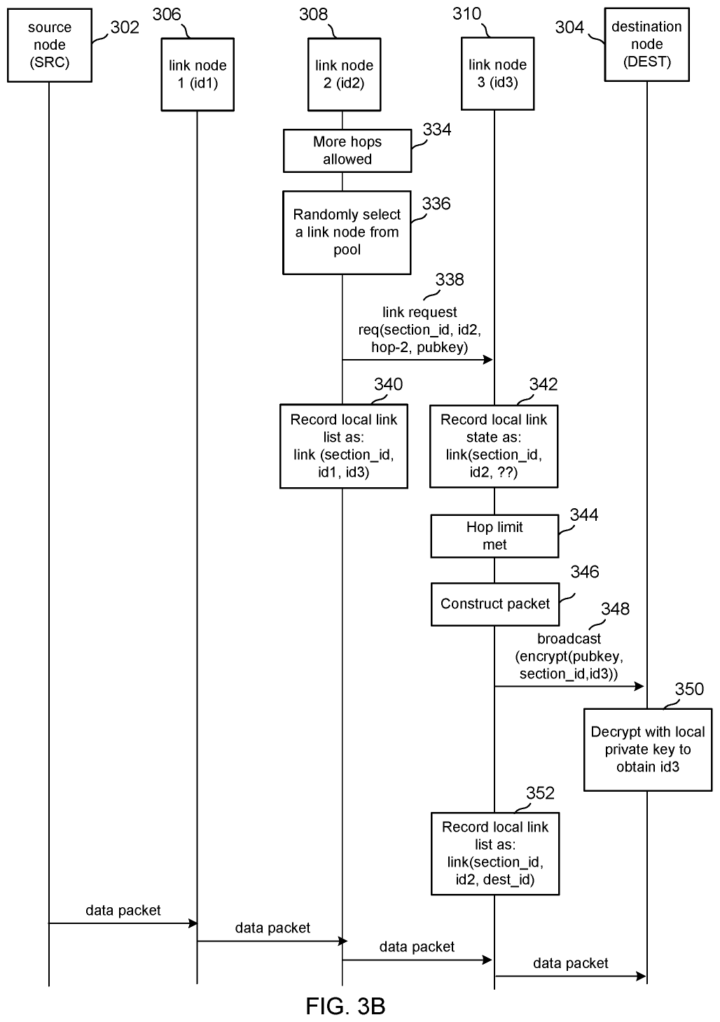

FIGS. 3A and 3B are flow diagrams of a process for creating an anonymous communication channel between two communicating nodes 302, 304 using one or more link nodes 306, 308, 310. The two communicating nodes 302, 304 may correspond to a source node SRC and a destination node DEST, as shown in FIG. 2, and may be included in the same shard. The link nodes 306, 308, 310 in FIGS. 3A and 3B may correspond to link nodes id1, id2, id3 included in a pool of link nodes of the link-node group 208 of FIG. 2.

The flow diagram of FIGS. 3A and 3B begins at a stage where the source node 302 and the destination node 304 are already aware of each other and need to communicate with each other. Accordingly, at 312, the destination node 304 broadcasts a communication request. The communication request includes an identification (dest_id) that identifies the destination node 304 and the public key (pubkey) of the destination node 304. This communication request does not include any communication information, e.g., content or data, intended for the destination node.

The communication request may be broadcast to the nodes in the underlying large-scale decentralized network 200, shown in FIG. 2. The source node 302 receives the broadcasted communication request and upon reading the request, it recognizes the dest id included therein and accordingly, further processes and validates the request. All other nodes in the network 200 read the request but they do not recognize the node identification (dest_id) and accordingly, ignore the broadcast.

Upon validation of the communication request by the source node 302, a communication channel between the source node 302 and the destination node 304 begins to be constructed using one or more available link nodes. As an initial step in constructing the communication channel, at block 314, the source node 302 assigns a section identification (section_id) for the communication channel being constructed. This section_id identifies the source node 302 and the destination node 304 and is included in all requests involved in the construction of the communication channel and thus is passed along to all link nodes that ultimately form the channel. After successful construction of the communication channel, any communication between the source node 302 and the destination node 304 over the communication channel is identified by this section_id.

At block 316, the source node 302 selects a first link node 306 having an associated identification number (id1) from a pool of available link. Link node selection by the source node 302 is conducted through the resource control mechanism 212 that manages the link-node group 208. In one embodiment, where the resource control mechanism 212 is embodied as a smart contract deployed in the public blockchain system, the source node 302 selects the first link node 306 from the link-node group 208 by calling the smart contract to return the identification number of the first link node. Upon receipt of the call, the resource control mechanism 212 randomly selects the first link node 306 for the source node 302 and sends the identification number (id1) of the first link node to the source node.

Upon receipt of the identification number (id1), the source node 302 sends a connection request 318 directly to the first link node 306. The connection request 318 includes the section_id, an identification of the source node 302 (src_id), information indicative of the number of links in the communication channel (hop, where hop may correspond to the total number of link nodes to be included in the communication channel), and the public key (pubkey) of the destination node 304.

Upon receipt of the link request 318, the first link node 306 processes the request and a first communication link is established between the source node 302 and the first link node. After the first communication link is established, at block 320, the source node 302 makes a record of the link in a local link list. The local link list for the source node 302 includes the communication channel identification (section_id) and the identification (id1) of the link node 306 with which the source node is now linked. The local link list functions as a routing table for the source node 302 in that it identifies the node (link node 306) to which the source node is to send communication information intended for the destination node 304.

Similarly, after the first communication link is established, at block 322, the first link node 306 makes a record of the link in a local link state. The local link state for the first link node 306 includes the communication channel identification (section_id), the identification (src_id) of the source node 302 with which the first link node now linked, and a to-be-determined identification (??) of the next link node, if any, in the communication channel. Eventually, upon establishment of the next link in the communication channel, the local link state record of the first link node 306 is updated into a local link list that functions as a routing table for the first link node that identifies the node from which the first link node receives communication information and the node to which the first link node is to send communication information intended for the destination node 304.

At block 324, the first link node 306 determines whether a next link node should be selected to create another communication link in the communication channel between the source node 302 and the destination node. This determination may be based on the hop information included in the link request 318. To this end, the first link node 306 decrements the value of hop by one and proceeds accordingly, depending on whether the result is greater than zero or not. Assuming at this stage in the example flow of FIG. 3A the result is greater than zero, the first link node proceeds to block 326, where it selects a second link node 308 having an associated identification number (id2) from the pool of available link nodes. Link node selection by the first link node 306 is conducted through the resource control mechanism 212 that manages the link-node group 208. In one embodiment, where the resource control mechanism 212 is embodied as a smart contract deployed in the public blockchain system, the first link node 306 selects the second link node 308 from the link-node group 208 by calling the smart contract to return the identification number of the second link node. Upon receipt of the call, the resource control mechanism 212 randomly selects the second link node 308 for the first link node 306 and sends the identification number (id2) of the second link node to the first link node.

Upon receipt of the identification number (id2), the first link node 306 and sends a connection request 328 directly to the second link node 308. The connection request 328 includes the communication channel identification (section_id), an identification of the first link node 306 (id1), information indicative of the remaining number of links in the communication channel (hop-1, where hop may correspond to the remaining number of link nodes to be included in the communication channel), and the public key (pubkey) of the destination node 304.

Upon receipt of the link request 328, the second link node 308 processes the request and a second communication link is established between the first link node 306 and the second link node. After the second communication link is established, at block 330, the first link node 306 makes a record of the link in a local link list. The local link list for the first link node 306 is essentially an update of the local link state recorded in block 322 and includes the communication channel identification (section_id), the identification (src_id) of the source node 302, and the identification (id2) of the second link node 308 with which the first link node 306 is now linked. The local link list functions as a routing table for the first link node 306 in that it identifies the node (source node 302) from which the first link node receives communication information and the node (second link node 308) to which the first link node is to send communication information intended for the destination node 304.

Also, after the second communication link is established, at block 332, the second link node 308 makes a record of the link in a local link state. The local link state for the second link node 308 includes the communication channel identification (section_id), the identification (id1) of the first link node 306 with which the second link node linked, and a to-be-determined identification (??) of the next link node, if any, in the communication channel. Eventually, upon establishment of the next link in the communication channel, the local link state record of the second link node 308 is updated into a local link list that functions as a routing table for the second link node that identifies the node from which the second link node receives communication information and the node to which the second link node is to send communication information intended for the destination node 304.

With reference to FIG. 3B, at block 334, the second link node 308 determines whether a next link node should be selected to create another communication link in the communication channel between the source node 302 and the destination node. This determination may be based on the hop-1 information included in the link request 328. To this end, the second link node 308 decrements the value of hop-1 by one and proceeds accordingly, depending on whether the result is greater than zero or not. Assuming again at this stage in the example flow of FIG. 3A that the result is greater than zero, the second link node proceeds to block 336, where it selects a third link node 310 having an associated identification number (id3) from the pool of available link nodes. Link node selection by the second link node 308 is conducted through the resource control mechanism 212 that manages the link-node group 208. In one embodiment, where the resource control mechanism 212 is embodied as a smart contract deployed in the public blockchain system, the second link node 308 selects the third link node 310 from the link-node group 208 by calling the smart contract to return the identification number of the third link node. Upon receipt of the call, the resource control mechanism 212 randomly selects the third link node 310 for the second link node 308 and sends the identification number (id3) of the third link node to the second link node.

Upon receipt of the identification number (id3), the second link node 308, sends a connection request 338 directly to the third link node 310. The connection request 338 includes the communication channel identification (section_id), an identification of the second link node 308 (id2), information indicative of the remaining number of links in the communication channel (hop-2, where hop may correspond to the remaining number of link nodes to be included in the communication channel), and the public key (pubkey) of the destination node 304.

Upon receipt of the link request 338, the third link node 310 processes the request and a third communication link is established between the second link node 308 and the third link node. After the third communication link is established, at block 340, the second link node 308 makes a record of the link in a local link list. The local link list for the second link node 308 is essentially an update of the local link state recorded in block 332 and includes the communication channel identification (section_id), the identification (id1) of the first link node 306, and the identification (id3) of the third link node 310 with which the second link node 308 is now linked. The local link list functions as a routing table for the second link node 308 in that it identifies the node (first link node 306) from which the second link node receives communication information and the node (third link node 310) to which the second link node should send communication information intended for the destination node 304.

Also, after the third communication link is established, at block 342, the third link node 310 makes a record of the link in a local link state. The local link state for the third link node 310 includes the communication channel identification (section_id), the identification (id2) of the second link node 308 with which the third link node linked, and a to-be-determined identification (??) of the next link node, if any, in the communication channel.

At block 344, the third link node 310 determines whether a next link node should be selected to create another communication link in the communication channel between the source node 302 and the destination node. This determination may be based on the hop-2 information included in the link request 338. To this end, the third link node 310 decrements the value of hop-2 by one and proceeds accordingly, depending on whether the result is greater than zero or not. Assuming at this stage in the example flow of FIG. 3A that the result is zero, the third link does not select another link node and instead proceeds to block 346. Note that the value hop is configurable and allows for the user to determine the level of anonymity of the communication channel, with the greater value of hop resulting in a greater number of link nodes and communication links, which makes the communication channel more anonymous.

At block 346, the third link node 310 constructs an encrypted packet that is encrypted with public key (pubkey) of the destination node 304 and contains as its encrypted content the communication channel identification (section_id) and the identification (id3) of the third link node 310. Note that the packet does not include any communication information and its content is used to establish the final or last communication link in the communication channel. At 348, the third link node 310 broadcasts the packet to the nodes 202 in the underlying large-scale decentralized network 200 shown in FIG. 2.

At block 350, the destination node 304 receives the broadcast packet and recognizes the public key, and accordingly, decrypts the packet with the local private key. All other nodes in the network 200 ignore the broadcast. Within the decrypted packet, the destination node 304 further recognizes that the communication channel identification (section_id) identifies the destination node 304 as an end node of the constructed communication channel. The destination node 304 then establishes a communication link with the third link node 310. Optionally, the destination node 304 may send a connection request to the third link node 310 to confirm establishment of the final communication link. This is optional, as the third node 310 knows, based on the local link list recorded at block 352 below, to send communication information to the destination node 304.

At block 352, after the final communication link between the third node 310 and the destination node 304 is established, the third link node 310 makes a record of the link in a local link list. The local link list for the third link node 310 is essentially an update of the local link state recorded in block 342 and includes the communication channel identification (section_id), the identification (id2) of the second link node 308, and the identification (dest_id) of the destination node 304 with which the third link node 310 is now linked. The local link list functions as a routing table for the third link node 310 in that it identifies the node (second link node 308) from which the third link node receives communication information and the node (destination node 304) to which the third link node should send communication information intended for the destination node 304.

With continued reference to FIG. 3B, now that a communication channel is established between the source node 302 and the destination node 304, communication information may be transmitted from one end of the channel to the other end of the channel through the link nodes 306, 308, 310. To this end, and with reference to the bottom of FIG. 3B, a data packet from the source node 302 is transmitted directly to the first link node 306 based on routing information provided by the local link list (section_id, id1) recorded at the source node. The local link list functions as a look-up table that lists for the source node 302, the node (id1) to which it should retransmit packets it has received that are identified as belonging to the listed communication channel identification (section_id).

Next, the data packet is transmitted from the first link node 306 directly to the second link node 308 based on routing information provided by the local link list (section_id, src_id, id2) recorded at the first link node. Here, the local link list functions as a look-up table that lists for the first link node 306, the nodes to which it should retransmit packets it has received that are identified as belonging to the listed communication channel identification (section_id). Packets received from the source node (src_id) are retransmitted to second link node (id2), while packets received from the second link node (id2) are retransmitted to the source node (src_id).

Next, the data packet is transmitted from the second link node 308 directly to the third link node 310 based on routing information provided by the local link list (section_id, id1, id3) recorded at the second link node. Here, the local link list functions as a look-up table that lists for the second link node 308, the nodes to which it should retransmit packets it has received that are identified as belonging to the listed communication channel identification (section_id). Packets received from the first link node (id1) are retransmitted to the third link node (id3), while packets received from the third link node (id3) are retransmitted to the first link node (id1).

Finally, the data packet is transmitted from the third link node 310 directly to the destination node 304 based on routing information provided by the local link list (section_id, id2, dest_id) recorded at the third link node. Here, the local link list functions as a look-up table that lists for the third link node 310, the nodes to which it should retransmit packets it has received that are identified as belonging to the listed communication channel identification (section_id). Packets received from the second link node (id2) are retransmitted to the destination node (dest_id), while packets received from the destination node (dest_id) are retransmitted to the second link node (id2).

Thus, the data packet is serially transmitted, through each link node forming the communication channel between the source node 302 and the destination node 304. Communication in the opposite direction, from the destination node 304 to the source node 302, may also occur over the constructed communication channel, with each node applying the routing information in its local link list in reverse order, as described above. In either direction, communication between the source node 302 and the destination node 304 is completed without any one of the source node, the destination node or link nodes having knowledge of the entire series of nodes defining the communication channel. In other words, each node in the communication channel knows through its recorded local link list only the two nodes to which it is connected, and does not have a global view of the entire communication channel. Thus, communication between the nodes has a high degree of anonymity.

While the foregoing process flow describes the construction of a single communication channel, the process may be repeated to construct additional communication channels between different nodes within a single shard. The process may also be used to construct communication channels between nodes in different shards in a large-scale decentralized network. The process thus enables the formation of a network that is both secure and anonymous. The process also allows for communication of information between nodes that does not rely on broadcasting. Thus, network resources typically expended on broadcast reception and processing are preserved.

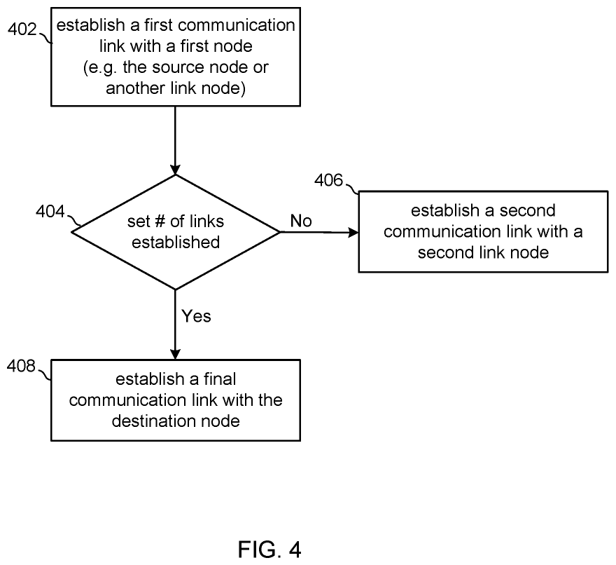

FIG. 4 is a flowchart of a method of constructing at least a portion of a communication channel between a source node and a destination node. The method may be performed, for example, by each of the link nodes id1, id2, id3 in the link-node group 208 of the large-scale decentralized network 200 shown in FIG. 2 (or the link nodes 306, 308, 310 shown in FIG. 3) in order to establish the entirety of the communication channel between the source node SRC and the destination node DEST.

With reference to FIG. 3A, and assuming link node 306 is performing the method of FIG. 4, at block 402, the link node 306 (herein after referred to as the first link node) establishes a first communication link with a first node 302 corresponding to a source node SRC. To this end, the first link node 306 may receive a link request from the first node 302 including a section identification identifying the communication channel, a node identifier identifying the first node 302 that transmitted the request, a first hop value indicative of the number of communication links to be established, and a public key of the destination node 304. The first hop value may correspond to the number of link nodes to be included in the formation of the communication channel. For example, in FIG. 3, the hop value is three, which results in a total of four communication links between the source node 302 and the destination node 304.

At block 404, the first ink node 306 determines if a predetermined number of communication links has or has not been established. This determination is based on the first hop value included in the link request. The first link node 306 processes the first hop value by decrementing its value by one. If the outcome is greater than zero, the first link node 306 concludes that the predetermined number of communication links has not been established. In this example, the hop value is three, the outcome by link node 306 is two, so the first link node concludes that the predetermined number of communication links has not been established, and the process proceeds to block 406.

At block 406, because the outcome of block 404 is negative, meaning a predetermined number of communication links has not been established, the first link node 306 establishes a second communication link with a second link node 308. To establish the second communication link, the first link node 306 selects the second link node 308 from a pool of link nodes, and transmits a link request to the second link node. This link request includes a section identification identifying the communication channel, a node identifier identifying the first link node, a second hop value indicative of a remaining number of communication links to be established, and a public key of the destination node. In one configuration, the first link node 306 selects the second link node 308 by requesting a node identifier corresponding to a link node from a resource control mechanism 212 that manages the pool of link nodes. In one embodiment, where the resource control mechanism 212 is embodied as a smart contract deployed in the public blockchain system, the first link node 306 selects the second link node 308 from the link-node group 208 by calling the smart contract to return the node identifier of the second link node 308, as described above with reference to FIGS. 3A and 3B. Upon establishment of the second communication link with the second link node 308, the first link node 306 stops performing the method of FIG. 4.

With reference to FIG. 3B, and assuming link node 310 is performing the method of FIG. 4, at block 402, the link node 310 (herein after referred to as the first link node) establishes a first communication link with a first node 308 corresponding to another link node. To this end, the first link node 310 may receive a link request from the first node 308 including a section identification identifying the communication channel, a node identifier identifying the first node 308 that transmitted the request, a first hop value indicative of the number of communication links to be established, and a public key of the destination node 304. The first hop value may correspond to the number of remaining link nodes to be included in the formation of the communication channel. For example, in FIG. 3 and with respect to link node 310, the hop value is one.

At block 404, the first ink node 310 determines if a predetermined number of communication links has or has not been established. This determination is based on the first hop value included in the link request. The first link node 310 processes the first hop value by decrementing its value by one. If the outcome is zero, the first link node 310 concludes that the predetermined number of communication links has not been established. In this example, the hop value is one, the outcome by link node 310 is zero so the first link node concludes that the predetermined number of communication links has been established, and the process proceeds to block 408.

At block 408, the first link node 310 initiates establishment of a final communication link with the destination node 304. To this end, the first link node 310 broadcasts a packet comprising a section identification identifying the communication channel, a node identifier identifying the first link node, and a public key of the destination node. The information included in this packet, once processed by the destination node 304, establishes a final communication link between the first link node 310 and the destination node. Upon establishment of the final communication link with the destination node 304, the first link node 310 stops performing the method of FIG. 4.

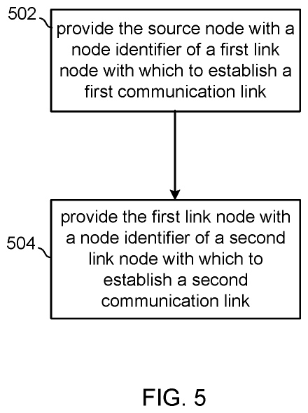

FIG. 5 is a flowchart of method a facilitating construction of a communication channel between a source node SRC and a destination node DEST in a large-scale decentralized network 200, such as the one shown in FIG. 2. The method may be performed, for example, by a resource control mechanism 212 available to the large-scale decentralized network 200.

At block 502, the resource control mechanism 212 provides the source node SRC with a node identifier identifying a first link node id1. The first link node id1 is one of a plurality of link nodes 210 within the link-node group 208 that may be selected to establish a communication link of the communication channel. The source node and the destination node may be in a first shard of the network 200, while the plurality of link nodes 210 within the pool are outside the first shard. Using link nodes outside of the shard of the source node SRC and the destination node DEST to construct a communication channel—as opposed to other nodes with the shard—reduces the burden on the other nodes in the shard and provides a higher degree of anonymity to the communication channel.

The resource control mechanism 212 provides the node identifier in response to a request by the source node SCR. To this end, the resource control mechanism 212 receives a request for a node identifier from the source node SRC. The resource control mechanism 212 may randomly select the node identifier corresponding to the first link node id1 from a pool of available link nodes 210, and then send the selected node identifier to the source node SRC. As previously mentioned, the resource control mechanism 212 may be implemented as a smart contract in a blockchain environment, in which case the random selection of a link node is implemented as a function call on the smart contract. Any node 202 can call that function to randomly selected one available link node.

In one configuration, each of the link nodes 210 in the pool of link nodes 208 is assigned a capacity value indicating the number of times the node identifier corresponding to a node may be selected. In this case, as part of the node identifier selection process, prior to sending the selected node identifier to the source node SRC, the resource control mechanism 212 ensures the capacity value of the node corresponding to the selected node identifier is not exceeded. For example, if the capacity value for the first link node id1 is four and the first link node id1 has only twice been previously selected, then the resource control mechanism 212 would send the selected node identifier for node id1. However, if the capacity value for the first link node id1 is only two, the resource control mechanism 212 would refrain from sending the selected node identifier for node id1, and would instead select another node identifier from the pool of available link nodes 210 in the link-node group 208.

At block 504, the resource control mechanism 212 provides the first link node idl with a node identifier identifying a second link node id2. The second link node id2 is one of a plurality of link nodes 210 within the link-node group 208 selectable for use in establishing a second communication link of the communication channel.

The resource control mechanism 212 provides the node identifier in response to a request by the first link node id1. To this end, the resource control mechanism 212 receives a request for a node identifier from the first link node id1. The resource control mechanism 212 selects the node identifier corresponding to the second link node id2, and then sends the selected node identifier to the first link node id1. As mention above, each of the link nodes 210 in the pool of link nodes 208 may be assigned a capacity value indicating the number of times the node identifier corresponding to a node may be selected. In this case, as part of the node identifier selection process, prior to sending the selected node identifier to the first link node id1, the resource control mechanism 212 ensures the capacity value of the node corresponding to the selected node identifier is not exceeded.

The link-node group 208 is managed by the resource control mechanism 212. For example, the resource control mechanism 212 may add and remove link nodes 202 to and from the group in accordance with the performance of a link node. To this end, the resource control mechanism 212 may monitor the number of times a link node 210 has been selected for use in establishing a communication link, and compare it against a capacity value assigned to the link node that limits the number of times a link node may be selected. Once a link node 210 has met its capacity value, the resource control mechanism 212 may remove that link node from the link-node group 208. The resource control mechanism 212 may add a link node 202 to the link-node group 208 upon one or more conditions being met by the link node. In one configuration, a link node 202 is required to post a bond in order to join the link-node group 208, and its capacity value may be based on the amount of bond posted. For example, a link node 202 posting “x” tokens of cryptocurrency may be assigned a capacity value equal to “x.”

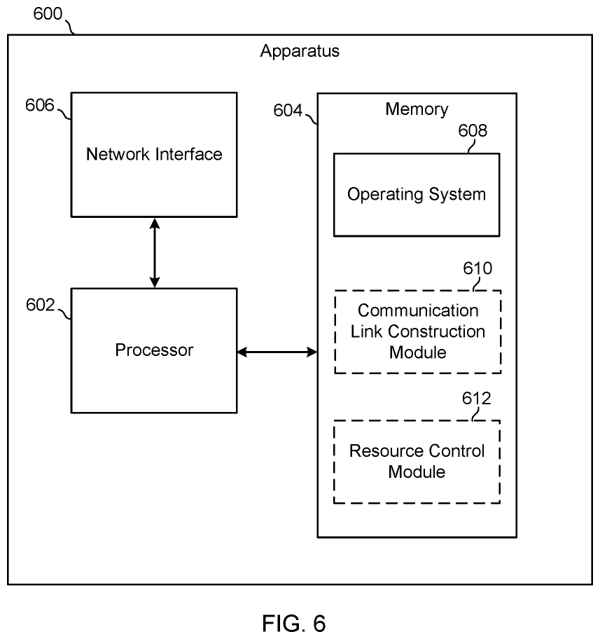

FIG. 6 is a schematic block diagram of an apparatus 600. The apparatus 600 may correspond to a link node 210 configured to enable the method of constructing a communication channel described above with reference to FIGS. 3A and 3B and FIG. 4. Alternatively, the apparatus 600 may correspond to a resource control mechanism 212 configured to enable the method of facilitating construction a communication channel described above with reference to FIG. 5.

The apparatus 600 may include one or more processors 602 configured to access and execute computer-executable instructions stored in at least one memory 604. The processor 602 may be implemented as appropriate in hardware, software, firmware, or combinations thereof. Software or firmware implementations of the processor 602 may include computer-executable or machine-executable instructions written in any suitable programming language to perform the various functions described herein. The processor 602 may include, without limitation, a central processing unit (CPU), a digital signal processor (DSP), a reduced instruction set computer (RISC) processor, a complex instruction set computer (CISC) processor, a microprocessor, a microcontroller, a field programmable gate array (FPGA), a System-on-a-Chip (SOC), or any combination thereof. The apparatus 600 may also include a chipset (not shown) for controlling communications between the processor 602 and one or more of the other components of the apparatus 600. The processor 602 may also include one or more application-specific integrated circuits (ASICs) or application-specific standard products (ASSPs) for handling specific data processing functions or tasks.

The memory 604 may include, but is not limited to, random access memory (RAM), flash RAM, magnetic media storage, optical media storage, and so forth. The memory 604 may include volatile memory configured to store information when supplied with power and/or non-volatile memory configured to store information even when not supplied with power. The memory 604 may store various program modules, application programs, and so forth that may include computer-executable instructions that upon execution by the processor 602 may cause various operations to be performed. The memory 604 may further store a variety of data manipulated and/or generated during execution of computer-executable instructions by the processor 602.

The apparatus 600 may further include one or more network interfaces 606 that may facilitate communication between the apparatus 600 and one or more other nodes using any suitable communications standard. For example, a LAN interface may implement protocols and/or algorithms that comply with various communication standards of the Institute of Electrical and Electronics Engineers (IEEE), such as IEEE 802.11, while a cellular network interface implement protocols and/or algorithms that comply with various communication standards of the Third Generation Partnership Project (3GPP) and 3GPP2, such as 3G and 4G (Long Term Evolution), and of the Next Generation Mobile Networks (NGMN) Alliance, such as 5G.

The memory 604 may store various program modules, application programs, and so forth that may include computer-executable instructions that upon execution by the processor 602 may cause various operations to be performed. For example, the memory 604 may include an operating system module (O/S) 608 that may be configured to manage hardware resources such as the network interface 606 and provide various services to applications executing on the apparatus 600.

If the apparatus 600 corresponds to a node, the memory 604 stores additional program modules such as a communication link construction module 610 which supports and enables the node to implement the communication channel construction functionalities described above with reference to FIGS. 3A and 3B and FIG. 4. The communication link construction module 610 includes computer-executable instructions that when executed by the processor 602 cause various operations to be performed. For example, the communication link construction module 610 may cause the node 600 to function as a first link node that establishes at least a portion of a communication channel between a source node and a destination node included in a decentralized network of nodes, as described above with reference to FIG. 4. More specifically, the communication link construction module 610 may cause the node 600 to establish a first communication link with a first node, establish a second communication link with a second link node when a predetermined number of communication links has not been established, and establish a final communication link with the destination node when the predetermined number of communication links has been established.

If the apparatus 600 corresponds to a resource control mechanism, the memory 604 stores additional program modules such as a link-node resource control module 612 which enables the resource control mechanism to oversee the communication channel construction functionalities described above with reference to FIG. 5. The link-node resource control module 612 includes computer-executable instructions, e.g., a smart contract, that when executed by the processor 602 cause various operations to be performed. For example, the link-node resource control module 612 may cause the resource control mechanism 600 to facilitate construction of a communication channel between a source node and a destination node, as described above with reference to FIG. 5. More specifically, the link-node resource control module 612 may cause the resource control mechanism 600 to provide a source node with a node identifier identifying a first link node within a pool of link nodes selectable for use in establishing a first communication link of the communication channel, and to provide the first link node with a node identifier identifying a second link node within the pool of link nodes selectable for use in establishing a second communication link of the communication channel.

The apparatus 600 and modules 610, 612 disclosed herein may be implemented in hardware or software that is executed on a hardware platform. The hardware or hardware platform may be a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a smart card, a flash memory device (e.g., card, stick, key drive), random access memory (RAM), read only memory (ROM), programmable ROM (PROM), erasable PROM (EPROM), electrically erasable PROM (EEPROM), a general register, or any other suitable non-transitory medium for storing software.

The various aspects of this disclosure are provided to enable one of ordinary skill in the art to practice the present invention. Various modifications to exemplary embodiments presented throughout this disclosure will be readily apparent to those skilled in the art. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of establishing at least a portion of a communication channel between a source node and a destination node, the method comprising:
establishing by a first link node, a first communication link with a first node;
establishing by the first link node, a second communication link with a second link node when a predetermined number of communication links has not been established; and
establishing by the first link node a final communication link with the destination node when the predetermined number of communication links has been established.

2. The method of claim 1, wherein establishing a first communication link with a first node comprises:
receiving at the first link node, a link request comprising a section identification identifying the communication channel, a node identifier identifying the first node that transmitted the request, a first hop value indicative of the number of communication links to be established, and a public key of the destination node.

3. The method of claim 1, wherein establishing a second communication link with a second link node comprises:
processing the first hop value to determine that the predetermined number of communication links has not been established;
selecting the second link node from a pool of link nodes; and
transmitting from the first link node to the second link node, a link request comprising a section identification identifying the communication channel, a node identifier identifying the first link node, a second hop value indicative of a remaining number of communication links to be established, and a public key of the destination node.

4. The method of claim 3, wherein processing the first hop value comprises determining that the first hop value is greater than zero.

5. The method of claim 3, wherein selecting the second link node comprises:
requesting a node identifier from a resource control mechanism, the node identifier corresponding to a link node included in the pool of link nodes; and
receiving the node identifier of the second link node.

6. The method of claim 1, wherein establishing a final communication link with the destination node comprises:
processing the first hop value to determine that the predetermined number of communication links has been established; and
broadcasting from the first link node a packet comprising a section identification identifying the communication channel, a node identifier identifying the first link node, and a public key of the destination node.

7. The method of claim 6, wherein processing the first hop value comprises determining that the first hop value is zero.

8. A first link node for establishing at least a portion of a communication channel between a source node and a destination node included in a decentralized network of nodes, the first link node comprising:
a network interface;
a memory; and
a processor coupled to the network interface and the memory and configured to:
establish by the first link node a first communication link with a first node;
establish by the first link node a second communication link with a second link node when a predetermined number of communication links has not been established; and
establish by the first link node a final communication link with the destination node when the predetermined number of communication links has been established.

9. The first link node of claim 8, wherein the processor establishes a first communication link with a first node by being further configured to:
receive at the first link node, a link request comprising a section identification identifying the communication channel, a node identifier identifying the first node that transmitted the request, a first hop value indicative of the number of communication links to be established, and a public key of the destination node.

10. The first link node of claim 8, wherein the processor establishes a second communication link with a second link node by being further configured to:
process the first hop value to determine that the predetermined number of communication links has not been established;
select the second link node from a pool of link nodes; and
transmit from the first link node to the second link node, a link request comprising a section identification identifying the communication channel, a node identifier identifying the first link node, a second hop value indicative of a remaining number of communication links to be established, and a public key of the destination node.

11. The first link node of claim 8, wherein the processor establishes a final communication link with the destination node by being further configured to:
process the first hop value to determine that the predetermined number of communication links has been established; and
broadcast from the first link node a packet comprising a section identification identifying the communication channel, a node identifier identifying the first link node, and a public key of the destination node.

12. A method of facilitating construction of a communication channel between a source node and a destination node, the method comprising:
providing the source node with a node identifier identifying a first link node within a pool of link nodes selectable for use in establishing a first communication link of the communication channel; and
providing the first link node with a node identifier identifying a second link node within the pool of link nodes selectable for use in establishing a second communication link of the communication channel.

13. The method of claim 12, wherein providing the source node with a node identifier comprises:
receiving a request for a node identifier from the source node; and
selecting the node identifier corresponding to the first link node; and
sending the selected node identifier to the source node.

14. The method of claim 13, wherein each link node in the pool of link nodes is assigned a capacity value indicating a number of times the node identifier corresponding to a node may be selected, and selecting the node identifier comprises ensuring the capacity value of the selected node identifier is not exceeded.

15. The method of claim 12, wherein providing the first link node with a node identifier comprises:
receiving a request for a node identifier from the first link node;
selecting the node identifier corresponding to the second link node; and
sending the selected node identifier to the first link node.

16. The method of claim 15, wherein each link node in the pool of link nodes is assigned a capacity value indicating a number of times the node identifier corresponding to a node may be selected, and selecting the node identifier comprises ensuring the capacity value of the selected node identifier is not exceeded.

17. The method of claim 12, wherein the source node and the destination node are in a first shard of a network and the nodes within the pool of link nodes are outside the first shard.

18. The method of claim 12, further comprising managing the pool of link nodes by:
allowing a link node to join the pool of link nodes based on a posting of a bond; and
assigning a capacity value to each of the nodes in the pool of link nodes based on the value of the posted bond.

19. A resource control mechanism for facilitating construction of a communication channel between a source node and a destination node, the resource control mechanism comprising:
a network interface;
a memory; and
a processor coupled to the network interface and the memory and configured to:
providing the source node with a node identifier identifying a first link node within a pool of link nodes selectable for use in establishing a first communication link of the communication channel; and
providing the first link node with a node identifier identifying a second link node within the pool of link nodes selectable for use in establishing a second communication link of the communication channel.

20. The resource control mechanism of claim 19, wherein the processor provides the source node with a node identifier by being further configured to:
receive a request for a node identifier from the source node; and
select the node identifier corresponding to the first link node; and
send the selected node identifier to the source node.

21. The resource control mechanism of claim 19, wherein processor provides the first link node with a node identifier by being further configured to:
receive a request for a node identifier from the first link node;
select the node identifier corresponding to the second link node; and
send the selected node identifier to the first link node.
